(19) United States
(12) Patent Application Publication
(10) Pub. No.: US 2025/0056610 A1
(43) Pub. Date: Feb. 13, 2025

(54) PARTIAL TWT COORDINATION IN WIRELESS NETWORKS

(71) Applicant: Samsung Electronics Co., Ltd., Suwon-si (KR)

(72) Inventors: Rubayet Shafin, Allen, TX (US); Boon Loong Ng, Plano, TX (US); Yue Qi, Plano, TX (US); Peshal Nayak, Plano, TX (US); Vishnu Vardhan Ratnam, Plano, TX (US); Elliot Jen, Taipei (TW)

(21) Appl. No.: 18/792,487

(22) Filed: Aug. 1, 2024

Related U.S. Application Data
(60) Provisional application No. 63/531,258, filed on Aug. 7, 2023.

(51) Int. Cl. H04W 74/0816; H04W 52/02; H04W 74/08

(52) U.S. Cl. CPC H04W 74/0816; H04W 52/0216; H04W 74/0866

(57) ABSTRACT

A first access point (AP) device in a wireless network is provided. The first AP comprises a memory and a processor coupled to the memory. The processor is configured to cause transmitting, to a second AP, a first frame requesting target wake time (TWT) based multi-AP coordination, the first frame including a set of TWT parameters for the TWT based multi-AP coordination. The processor is configured to cause receiving, from the second AP, a second frame indicating acceptance on a partial set of the TWT parameters requested from the first AP. The processor is configured to cause establishing the TW based multi-AP coordination with the second AP based on the partial set of TWT parameters.

### CROSS-REFERENCE TO RELATED APPLICATIONS

This application claims the benefit of priority from U.S. Provisional Application No. 63/531,258, entitled “METHOD AND APPARATUS FOR PARTIAL TWT COORDINATION,” filed Aug. 7, 2023, which is incorporated herein by reference in its entirety.

### TECHNICAL FIELD

This disclosure relates generally to a wireless communication system, and more particularly to, for example, but not limited to, target wake time (TWT) operation in wireless communication systems.

### BACKGROUND

Wireless local area network (WLAN) technology has evolved toward increasing data rates and continues its growth in various markets such as home, enterprise and hotspots over the years since the late 1990s. WLAN allows devices to access the internet in the 2.4 GHz, 5 GHZ, 6 GHz or 60 GHz frequency bands. WLANs are based on the Institute of Electrical and Electronic Engineers (IEEE) 802.11 standards. IEEE 802.11 family of standards aims to increase speed and reliability and to extend the operating range of wireless networks.

WLAN devices are increasingly required to support a variety of delay-sensitive applications or real-time applications such as augmented reality (AR), robotics, artificial intelligence (AI), cloud computing, and unmanned vehicles. To implement extremely low latency and extremely high throughput required by such applications, multi-link operation (MLO) has been suggested for the WLAN. The WLAN is formed within a limited area such as a home, school, apartment, or office building by WLAN devices. Each WLAN device may have one or more stations (STAs) such as the access point (AP) STA and the non-access-point (non-AP) STA.

The MLO may enable a non-AP multi-link device (MLD) to set up multiple links with an AP MLD. Each of multiple links may enable channel access and frame exchanges between the non-AP MLD and the AP MLD independently, which may reduce latency and increase throughput.

The description set forth in the background section should not be assumed to be prior art merely because it is set forth in the background section. The background section may describe aspects or embodiments of the present disclosure.

### SUMMARY

An aspect of the disclosure provides a first access point (AP) in a wireless network. The first AP comprises a memory and a processor coupled to the memory. The processor is configured to cause transmitting, to a second AP, a first frame requesting target wake time (TWT) based multi-AP coordination. The first frame includes a set of TWT parameters for the TWT based multi-AP coordination. The processor is configured to cause receiving, from the second AP, a second frame indicating acceptance on a partial set of the TWT parameters requested from the first AP. The processor is configured to cause establishing the TW based multi-AP coordination with the second AP based on the partial set of TWT parameters.

In some embodiments, the first frame includes an indication representing whether the first AP requests a complete acceptance for the set of the TWT parameters or a partial acceptance for the set of TWT parameters.

In some embodiments, the second frame includes an indication representing whether the second AP provides a complete acceptance for the set of the TWT parameters or a partial acceptance for the set of the TWT parameters.

In some embodiments, the first frame includes one or more TWT elements, each TWT element associated with a respective one of one or more TWT schedules that the first AP requests for the TWT based multi-AP coordination.

In some embodiments, each TWT element includes one or more TWT parameter sets, each TWT parameter set associated with a respective one of one or more TWT schedules which the first AP intends to coordinate on with the second AP.

In some embodiments, the second frame includes one or more TWT elements, each TWT element associated with a response to a respective one of one or more TWT schedules requested by the first AP.

In some embodiments, each TWT element includes one or more TWT parameter sets, each TWT parameter set associated with a response to a respective one of one or more TWT schedules requested by the first AP.

In some embodiments, each TWT parameter set indicates acceptance, rejection, or alternative to a TWT schedule requested by the first AP.

An aspect of the disclosure provides a first access point (AP) in a wireless network. The first AP comprises a memory and a processor coupled to the memory. The processor is configured to cause receiving, from a second AP, a first frame requesting target wake time (TWT) based multi-AP coordination. The first frame includes a set of TWT parameters for the TWT based multi-AP coordination. The processor is configured to cause transmitting, to the second AP, a second frame indicating acceptance on a partial set of the TWT parameters requested from the second AP. The processor is configured to cause establishing the TWT based multi-AP coordination with the second AP based on the partial set of TWT parameters.

In some embodiments, the first frame includes an indication representing whether the second AP requests a complete acceptance for the set of the TWT parameters or a partial acceptance for the set of TWT parameters.

In some embodiments, the second frame includes an indication representing whether the first AP provides a complete acceptance for the set of the TWT parameters or a partial acceptance for the set of the TWT parameters.

In some embodiments, the first frame includes one or more TWT elements, each TWT element associated with a respective one of one or more TWT schedules that the second AP requests for the TWT based multi-AP coordination.

In some embodiments, each TWT element includes one or more TWT parameter sets, each TWT parameter set associated with a respective one of one or more TWT schedules which the second AP intends to coordinate on with the first AP.

In some embodiments, the second frame includes one or more TWT elements, each TWT element associated with a response to a respective one of one or more TWT schedules requested by the second AP.

In some embodiments, each TWT element includes one or more TWT parameter sets, each TWT parameter set associated with a response to a respective one of one or more TWT schedules requested by the second AP.

In some embodiments, each TWT parameter set indicates acceptance, rejection, or alternative to a TWT schedule requested by the second AP.

An aspect of the disclosure provides a method performed by a first access point (AP) in a wireless network. The method comprises transmitting, to a second AP, a first frame requesting target wake time (TWT) based multi-AP coordination. The first frame includes a set of TWT parameters for the TWT based multi-AP coordination. The method comprises receiving, from the second AP, a second frame indicating acceptance on a partial set of the TWT parameters requested from the first AP. The method comprises establishing the TW based multi-AP coordination with the second AP based on the partial set of TWT parameters.

In some embodiments, the first frame includes an indication representing whether the first AP requests a complete acceptance for the set of the TWT parameters or a partial acceptance for the set of TWT parameters, and the second frame includes an indication representing whether the second AP provides the complete acceptance for the set of the TWT parameters or the partial acceptance for the set of the TWT parameters.

In some embodiments, the first frame includes one or more TWT elements, each TWT element associated with a respective one of one or more TWT schedules that the first AP requests for the TWT based multi-AP coordination, and each TWT element includes one or more TWT parameter sets, each TWT parameter set associated with a respective one of one or more TWT schedules which the first AP intends to coordinate on with the second AP.

In some embodiments, the second frame includes one or more TWT elements, each TWT element associated with a response to a respective one of one or more TWT schedules requested by the first AP, and each TWT element includes one or more TWT parameter sets, each TWT parameter set associated with a response to a respective one of one or more TWT schedules requested by the first AP.

### BRIEF DESCRIPTION OF THE DRAWINGS

FIG. 1 shows an example of a wireless network in accordance with an embodiment.

FIG. 2A shows an example of AP in accordance with an embodiment.

FIG. 2B shows an example of STA in accordance with an embodiment.

FIG. 3 shows an example of multi-link communication operation in accordance with an embodiment.

FIG. 4 shows an example of individual TWT operation in accordance with an embodiment.

FIG. 5 shows an example of broadcast TWT operation in accordance with an embodiment.

FIG. 6 shows an example of a typical AP development scenario for TWT based multi-AP coordination in accordance with an embodiment.

FIG. 7 shows an example scenario of a partial TWT agreement in accordance with an embodiment.

FIG. 8 shows another example scenario of a partial TWT agreement in accordance with an embodiment.

FIG. 9 shows another example scenario of a partial TWT agreement in accordance with an embodiment.

FIG. 10 shows another example scenario of a partial TWT agreement in accordance with an embodiment.

FIG. 11 shows a flow chart of an example operation of a partial TWT coordination in accordance with an embodiment.

FIG. 12 shows an example of frame exchanges in TWT-based MAP coordination in accordance with an embodiment.

FIG. 13 shows another example of frame exchanges in TWT-based MAP coordination in accordance with an embodiment.

FIG. 14 shows another example of frame exchanges in TWT-based MAP coordination in accordance with an embodiment.

FIG. 15 shows an example format of the TWT element in accordance with an embodiment.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below, in connection with the appended drawings, is intended as a description of various implementations and is not intended to represent the only implementations in which the subject technology may be practiced. Rather, the detailed description includes specific details for the purpose of providing a thorough understanding of the inventive subject matter. As those skilled in the art would realize, the described implementations may be modified in various ways, all without departing from the scope of the present disclosure. Accordingly, the drawings and description are to be regarded as illustrative in nature and not restrictive. Like reference numerals designate like elements.

The following description is directed to certain implementations for the purpose of describing the innovative aspects of this disclosure. However, a person having ordinary skill in the art will readily recognize that the teachings herein can be applied in a multitude of different ways. The examples in this disclosure are based on WLAN communication according to the Institute of Electrical and Electronics Engineers (IEEE) 802.11 standard, including IEEE 802.11be standard and any future amendments to the IEEE 802.11 standard. However, the described embodiments may be implemented in any device, system or network that is capable of transmitting and receiving radio frequency (RF) signals according to the IEEE 802.11 standard, the Bluetooth standard, Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), 5G NR (New Radio), AMPS, or other known signals that are used to communicate within a wireless, cellular or internet of things (IoT) network, such as a system utilizing 3G, 4G, 5G, 6G, or further implementations thereof, technology.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

Multi-link operation (MLO) is a key feature that is currently being developed by the standards body for next generation extremely high throughput (EHT) Wi-Fi systems in IEEE 802.11be. The Wi-Fi devices that support MLO are referred to as multi-link devices (MLD). With MLO, it is possible for a non-AP MLD to discover, authenticate, associate, and set up multiple links with an AP MLD. Channel access and frame exchange is possible on each link between the AP MLD and non-AP MLD.

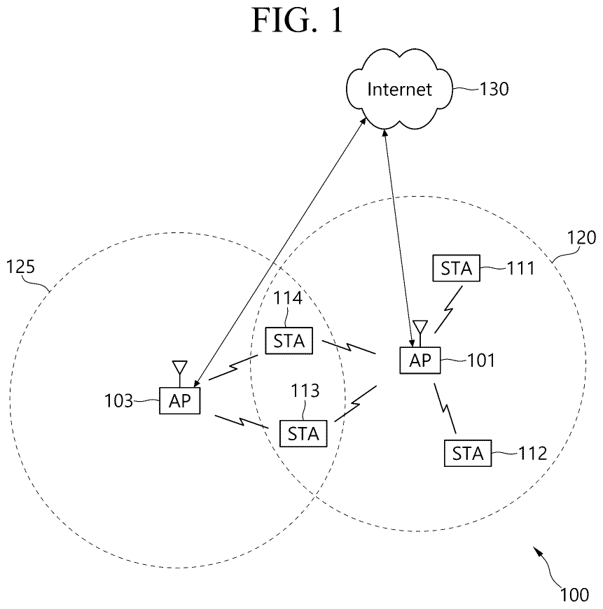

FIG. 1 shows an example of a wireless network 100 in accordance with an embodiment. The embodiment of the wireless network 100 shown in FIG. 1 is for illustrative purposes only. Other embodiments of the wireless network 100 could be used without departing from the scope of this disclosure.

As shown in FIG. 1, the wireless network 100 may include a plurality of wireless communication devices. Each wireless communication device may include one or more stations (STAs). The STA may be a logical entity that is a singly addressable instance of a medium access control (MAC) layer and a physical (PHY) layer interface to the wireless medium. The STA may be classified into an access point (AP) STA and a non-access point (non-AP) STA. The AP STA may be an entity that provides access to the distribution system service via the wireless medium for associated STAs. The non-AP STA may be a STA that is not contained within an AP-STA. For the sake of simplicity of description, an AP STA may be referred to as an AP and a non-AP STA may be referred to as a STA. In the example of FIG. 1, APs 101 and 103 are wireless communication devices, each of which may include one or more AP STAs. In such embodiments, APs 101 and 103 may be AP multi-link device (MLD). Similarly, STAs 111-114 are wireless communication devices, each of which may include one or more non-AP STAs. In such embodiments, STAs 111-114 may be non-AP MLD.

The APs 101 and 103 communicate with at least one network 130, such as the Internet, a proprietary Internet Protocol (IP) network, or other data network. The AP 101 provides wireless access to the network 130 for a plurality of stations (STAs) 111-114 with a coverage are 120 of the AP 101. The APs 101 and 103 may communicate with each other and with the STAs using Wi-Fi or other WLAN communication techniques.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

In FIG. 1, dotted lines show the approximate extents of the coverage area 120 and 125 of APs 101 and 103, which are shown as approximately circular for the purposes of illustration and explanation. It should be clearly understood that coverage areas associated with APs, such as the coverage areas 120 and 125, may have other shapes, including irregular shapes, depending on the configuration of the APs.

As described in more detail below, one or more of the APs may include circuitry and/or programming for management of MU-MIMO and OFDMA channel sounding in WLANs. Although FIG. 1 shows one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101 and 103 could communicate directly with the network 130 and provides STAs with direct wireless broadband access to the network 130. Further, the APs 101 and/or 103 could provide access to other or additional external networks, such as external telephone networks or other types of data networks.

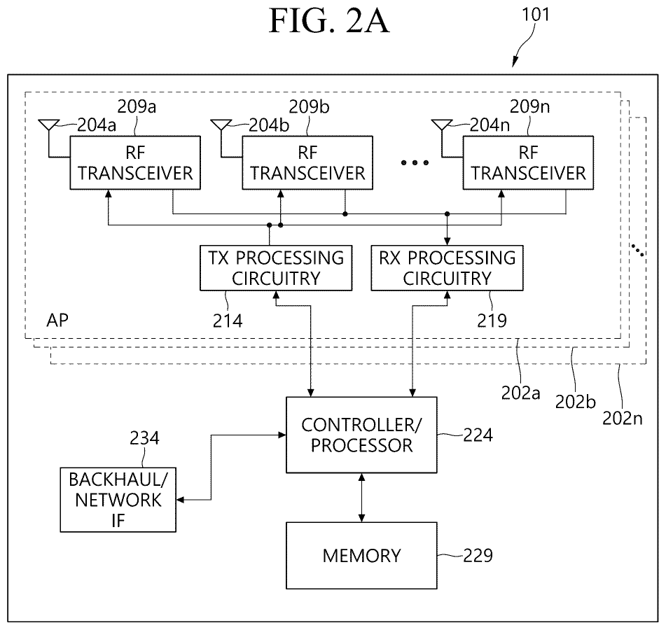

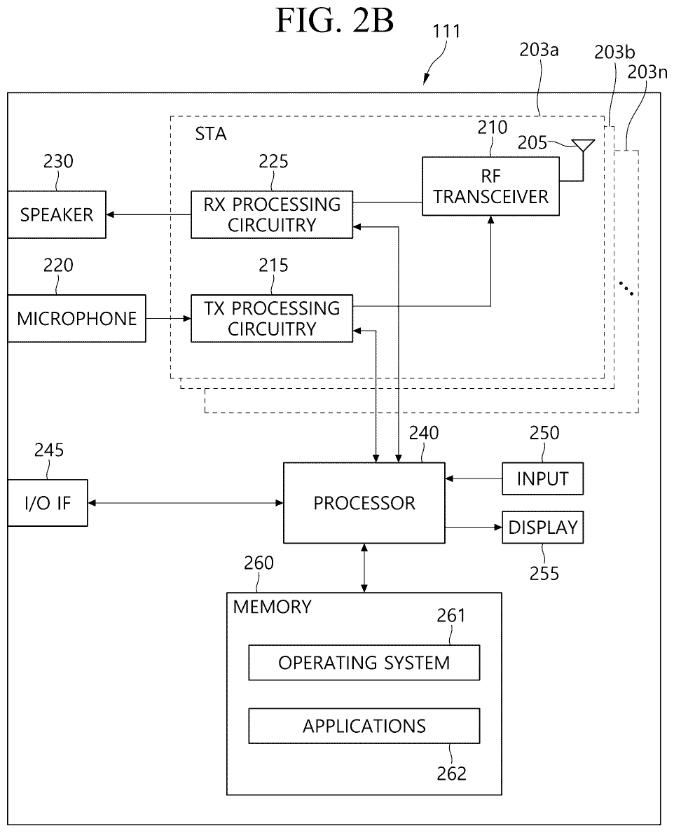

FIG. 2A shows an example of AP 101 in accordance with an embodiment. The embodiment of the AP 101 shown in FIG. 2A is for illustrative purposes, and the AP 103 of FIG. 1 could have the same or similar configuration. However, APs come in a wide range of configurations, and FIG. 2A does not limit the scope of this disclosure to any particular implementation of an AP.

As shown in FIG. 2A, the AP 101 may include multiple antennas 204a-204n, multiple radio frequency (RF) transceivers 209a-209n, transmit (TX) processing circuitry 214, and receive (RX) processing circuitry 219. The AP 101 also may include a controller/processor 224, a memory 229, and a backhaul or network interface 234. The RF transceivers 209a-209n receive, from the antennas 204a-204n, incoming RF signals, such as signals transmitted by STAs in the network 100. The RF transceivers 209a-209n down-convert the incoming RF signals to generate intermediate (IF) or baseband signals. The IF or baseband signals are sent to the RX processing circuitry 219, which generates processed baseband signals by filtering, decoding, and/or digitizing the baseband or IF signals. The RX processing circuitry 219 transmits the processed baseband signals to the controller/processor 224 for further processing.

The TX processing circuitry 214 receives analog or digital data (such as voice data, web data, e-mail, or interactive video game data) from the controller/processor 224. The TX processing circuitry 214 encodes, multiplexes, and/or digitizes the outgoing baseband data to generate processed baseband or IF signals. The RF transceivers 209a-209n receive the outgoing processed baseband or IF signals from the TX processing circuitry 214 and up-converts the baseband or IF signals to RF signals that are transmitted via the antennas 204a-204n.

The controller/processor 224 can include one or more processors or other processing devices that control the overall operation of the AP 101. For example, the controller/processor 224 could control the reception of uplink signals and the transmission of downlink signals by the RF transceivers 209a-209n, the RX processing circuitry 219, and the TX processing circuitry 214 in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support OFDMA operations in which outgoing signals are assigned to different subsets of subcarriers for different recipients (e.g., different STAs 111-114). Any of a wide variety of other functions could be supported in the AP 101 by the controller/processor 224 including a combination of DL MU-MIMO and OFDMA in the same transmit opportunity. In some embodiments, the controller/processor 224 may include at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP 101 to communicate with other devices or systems over a backhaul connection or over a network. The interface 234 could support communications over any suitable wired or wireless connection(s). For example, the interface 234 could allow the AP 101 to communicate over a wired or wireless local area network or over a wired or wireless connection to a larger network (such as the Internet). The interface 234 may include any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP 101 may include circuitry and/or programming for management of channel sounding procedures in WLANs. Although FIG. 2A illustrates one example of AP 101, various changes may be made to FIG. 2A. For example, the AP 101 could include any number of each component shown in FIG. 2A. As a particular example, an AP could include a number of interfaces 234, and the controller/processor 224 could support routing functions to route data between different network addresses. As another example, while shown as including a single instance of TX processing circuitry 214 and a single instance of RX processing circuitry 219, the AP 101 could include multiple instances of each (such as one per RF transceiver). Alternatively, only one antenna and RF transceiver path may be included, such as in legacy APs. Also, various components in FIG. 2A could be combined, further subdivided, or omitted and additional components could be added according to particular needs.

As shown in FIG. 2A, in some embodiment, the AP 101 may be an AP MLD that includes multiple APs 202a-202n. Each AP 202a-202n is affiliated with the AP MLD 101 and includes multiple antennas 204a-204n, multiple radio frequency (RF) transceivers 209a-209n, transmit (TX) processing circuitry 214, and receive (RX) processing circuitry 219. Each APs 202a-202n may independently communicate with the controller/processor 224 and other components of the AP MLD 101. FIG. 2A shows that each AP 202a-202n has separate multiple antennas, but each AP 202a-202n can share multiple antennas 204a-204n without needing separate multiple antennas. Each AP 202a-202n may represent a physical (PHY) layer and a lower media access control (MAC) layer.

FIG. 2B shows an example of STA 111 in accordance with an embodiment. The embodiment of the STA 111 shown in FIG. 2B is for illustrative purposes, and the STAs 111-114 of FIG. 1 could have the same or similar configuration. However, STAs come in a wide variety of configurations, and FIG. 2B does not limit the scope of this disclosure to any particular implementation of a STA.

As shown in FIG. 2B, the STA 111 may include antenna(s) 205, a RF transceiver 210, TX processing circuitry 215, a microphone 220, and RX processing circuitry 225. The STA 111 also may include a speaker 230, a controller/processor 240, an input/output (I/O) interface (IF) 245, a touchscreen 250, a display 255, and a memory 260. The memory 260 may include an operating system (OS) 261 and one or more applications 262.

The RF transceiver 210 receives, from the antenna(s) 205, an incoming RF signal transmitted by an AP of the network 100. The RF transceiver 210 down-converts the incoming RF signal to generate an IF or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the controller/processor 240 for further processing (such as for web browsing data).

The TX processing circuitry 215 receives analog or digital voice data from the microphone 220 or other outgoing baseband data (such as web data, e-mail, or interactive video game data) from the controller/processor 240. The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215 and up-converts the baseband or IF signal to an RF signal that is transmitted via the antenna(s) 205.

The controller/processor 240 can include one or more processors and execute the basic OS program 261 stored in the memory 260 in order to control the overall operation of the STA 111. In one such operation, the controller/processor 240 controls the reception of downlink signals and the transmission of uplink signals by the RF transceiver 210, the RX processing circuitry 225, and the TX processing circuitry 215 in accordance with well-known principles. The controller/processor 240 can also include processing circuitry configured to provide management of channel sounding procedures in WLANs. In some embodiments, the controller/processor 240 may include at least one microprocessor or microcontroller.

The controller/processor 240 is also capable of executing other processes and programs resident in the memory 260, such as operations for management of channel sounding procedures in WLANs. The controller/processor 240 can move data into or out of the memory 260 as required by an executing process. In some embodiments, the controller/processor 240 is configured to execute a plurality of applications 262, such as applications for channel sounding, including feedback computation based on a received null data packet announcement (NDPA) and null data packet (NDP) and transmitting the beamforming feedback report in response to a trigger frame (TF). The controller/processor 240 can operate the plurality of applications 262 based on the OS program 261 or in response to a signal received from an AP. The controller/processor 240 is also coupled to the I/O interface 245, which provides STA 111 with the ability to connect to other devices such as laptop computers and handheld computers. The I/O interface 245 is the communication path between these accessories and the main controller/processor 240.

The controller/processor 240 is also coupled to the input 250 (such as touchscreen) and the display 255. The operator of the STA 111 can use the input 250 to enter data into the STA 111. The display 255 may be a liquid crystal display, light emitting diode display, or other display capable of rendering text and/or at least limited graphics, such as from web sites. The memory 260 is coupled to the controller/processor 240. Part of the memory 260 could include a random access memory (RAM), and another part of the memory 260 could include a Flash memory or other read-only memory (ROM).

Although FIG. 2B shows one example of STA 111, various changes may be made to FIG. 2B. For example, various components in FIG. 2B could be combined, further subdivided, or omitted and additional components could be added according to particular needs. In particular examples, the STA 111 may include any number of antenna(s) 205 for MIMO communication with an AP 101. In another example, the STA 111 may not include voice communication or the controller/processor 240 could be divided into multiple processors, such as one or more central processing units (CPUs) and one or more graphics processing units (GPUs). Also, while FIG. 2B illustrates the STA 111 configured as a mobile telephone or smartphone, STAs could be configured to operate as other types of mobile or stationary devices.

As shown in FIG. 2B, in some embodiment, the STA 111 may be a non-AP MLD that includes multiple STAs 203a-203n. Each STA 203a-203n is affiliated with the non-AP MLD 111 and includes an antenna(s) 205, a RF transceiver 210, TX processing circuitry 215, and RX processing circuitry 225. Each STAs 203a-203n may independently communicate with the controller/processor 240 and other components of the non-AP MLD 111. FIG. 2B shows that each STA 203a-203n has a separate antenna, but each STA 203a-203n can share the antenna 205 without needing separate antennas. Each STA 203a-203n may represent a physical (PHY) layer and a lower media access control (MAC) layer.

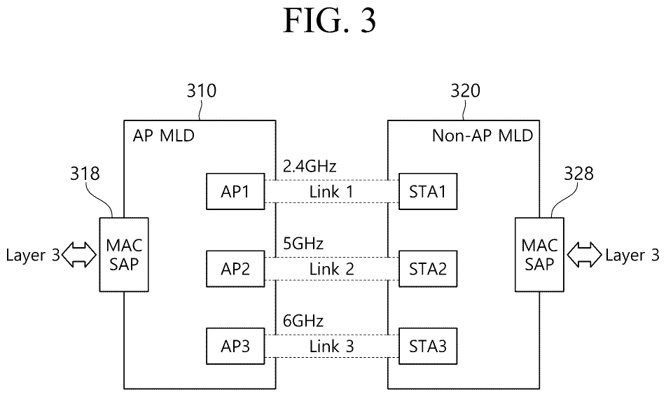

FIG. 3 shows an example of multi-link communication operation in accordance with an embodiment. The multi-link communication operation may be usable in IEEE 802.11be standard and any future amendments to IEEE 802.11 standard. In FIG. 3, an AP MLD 310 may be the wireless communication device 101 and 103 in FIG. 1 and a non-AP MLD 220 may be one of the wireless communication devices 111-114 in FIG. 1.

As shown in FIG. 3, the AP MLD 310 may include a plurality of affiliated APs, for example, including AP 1, AP 2, and AP 3. Each affiliated AP may include a PHY interface to wireless medium (Link 1, Link 2, or Link 3). The AP MLD 310 may include a single MAC service access point (SAP) 318 through which the affiliated APs of the AP MLD 310 communicate with a higher layer (Layer 3 or network layer). Each affiliated AP of the AP MLD 310 may have a MAC address (lower MAC address) different from any other affiliated APs of the AP MLD 310. The AP MLD 310 may have a MLD MAC address (upper MAC address) and the affiliated APs share the single MAC SAP 318 to Layer 3. Thus, the affiliated APs share a single IP address, and Layer 3 recognizes the AP MLD 310 by assigning the single IP address.

The non-AP MLD 320 may include a plurality of affiliated STAs, for example, including STA 1, STA 2, and STA 3. Each affiliated STA may include a PHY interface to the wireless medium (Link 1, Link 2, or Link 3). The non-AP MLD 320 may include a single MAC SAP 328 through which the affiliated STAs of the non-AP MLD 320 communicate with a higher layer (Layer 3 or network layer). Each affiliated STA of the non-AP MLD 320 may have a MAC address (lower MAC address) different from any other affiliated STAs of the non-AP MLD 320. The non-AP MLD 320 may have a MLD MAC address (upper MAC address) and the affiliated STAs share the single MAC SAP 328 to Layer 3. Thus, the affiliated STAs share a single IP address, and Layer 3 recognizes the non-AP MLD 320 by assigning the single IP address.

The AP MLD 310 and the non-AP MLD 320 may set up multiple links between their affiliate APs and STAs. In this example, the AP 1 and the STA 1 may set up Link 1 which operates in 2.4 GHz band. Similarly, the AP 2 and the STA 2 may set up Link 2 which operates in 5 GHZ band, and the AP 3 and the STA 3 may set up Link 3 which operates in 6 GHz band. Each link may enable channel access and frame exchange between the AP MLD 310 and the non-AP MLD 320 independently, which may increase date throughput and reduce latency. Upon associating with an AP MLD on a set of links (setup links), each non-AP device is assigned a unique association identifier (AID).

The following documents are hereby incorporated by reference in their entirety into the present disclosure as if fully set forth herein: i) IEEE 802.11-2020, “Wireless LAN Medium Access Control (MAC) and Physical Layer (PHY) Specifications,” ii) IEEE 802.11ax-2021, “Wireless LAN Medium Access Control (MAC) and Physical Layer (PHY) Specifications,” and ii) IEEE P802.11be/D3.1, “Wireless LAN Medium Access Control (MAC) and Physical Layer (PHY) Specifications.”

Target wake time (TWT) operation is a feature of power management in WLAN networks. The TWT operation has been introduced in IEEE 802.11ah standard and later modified in IEEE 802.11ax standard. The TWT operation enables an AP to manage activity in the basic service set (BSS) to minimize contention between STAs and reduce the required wake times for STAs during the TWT operation. It may be achieved by allocating STAs to operate at non-overlapping times or frequencies and perform the frame exchange sequences in pre-scheduled service periods. In TWT operation, a STA can wake up at pre-scheduled times that have been negotiated with an AP or another STA in the BSS. The STA does not need to be aware of TWT parameter values of other STAs within the BSS or of STAs in other BSSs. The STA does not need to be aware that a TWT service period (SP) is used to exchange frames with other STAs. Frames transmitted during a TWT SP can employ any PPDU (physical layer protocol data unit) format supported by the pair of STAs that have established the corresponding TWT agreement, including, but not limited to, HE MU (high efficiency multi-user) PPDU, HE TB (high efficiency trigger based) PPDU.

IEEE 802.11 standard describes two types of TWT operations: individual TWT operation and broadcast TWT operation. In the individual TWT operation, an individual TWT agreement can be established between two STAs or between a STA and an AP. The negotiation for the individual TWT operation may occur between two STAs or between a STA and an AP on an individual basis. An AP may have TWT agreements with multiple STAs. Any changes in the TWT agreement between the AP and one STA do not affect the TWT agreement between the AP and other STAs.

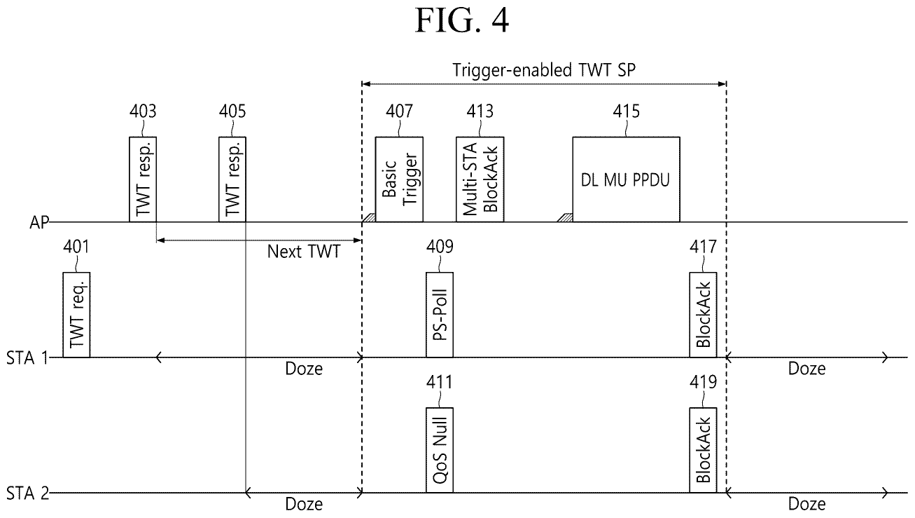

FIG. 4 shows an example of individual TWT operation in accordance with an embodiment. The operation depicted in FIG. 4 is for illustration purposes and does not limit the scope of this disclosure to any particular implementations.

In FIG. 4, STA 1 and STA 2 are TWT requesting STAs, and AP is a TWT responding STA. In the example of FIG. 4, STA 1 sends a TWT request 401 to AP to set up a trigger-enabled TWT agreement. The AP accepts the TWT request 401 with STA 1 and confirms the acceptance in TWT response 403 sent to STA 1. Subsequently, the AP sends an unsolicited TWT response 405 to STA 2 to set up a trigger-enabled TWT agreement with STA 2. Both these TWT agreements are set up as announced TWTs. During the trigger-enabled TWT SP, the AP sends a Basic Trigger frame 407 to the TWT requesting STAs (STA 1 and STA 2) which may indicate that they are awake during the TWT SP. STA 1 indicates that it is awake by sending a PS (power save)-Poll frame 409, and STA 2 indicates that it is awake by sending QoS (quality of service) Null frame 411 in response to the Basic Trigger frame 407. Subsequently, the AP sends a Multi-STA Block Ack 413 frame and DL MU (downlink multi-user) PPDU 415 to both STA 1 and STA 2. Afterward, STA 1 and STA 2 respectively send BlockAck frames 417 and 419 to the AP, and then go to doze state.

On the other hand, the broadcast TWT operates in a membership-based approach. In broadcast TWT operation, an AP can set up a shared TWT session for a group of STAs. The AP is typically the controller of the broadcast TWT schedule. The non-AP STAs in the BSS can request membership in the broadcast TWT schedule, or the AP can send unsolicited response to a STA to make the STA a member of the broadcast TWT schedule that the AP maintains in the BSS. The AP may advertise and maintain multiple broadcast TWT schedules in the BSS. When a change is made to any broadcast TWT schedules in the BSS, it may affect all or some of STAs that are members of the corresponding broadcast TWT schedule.

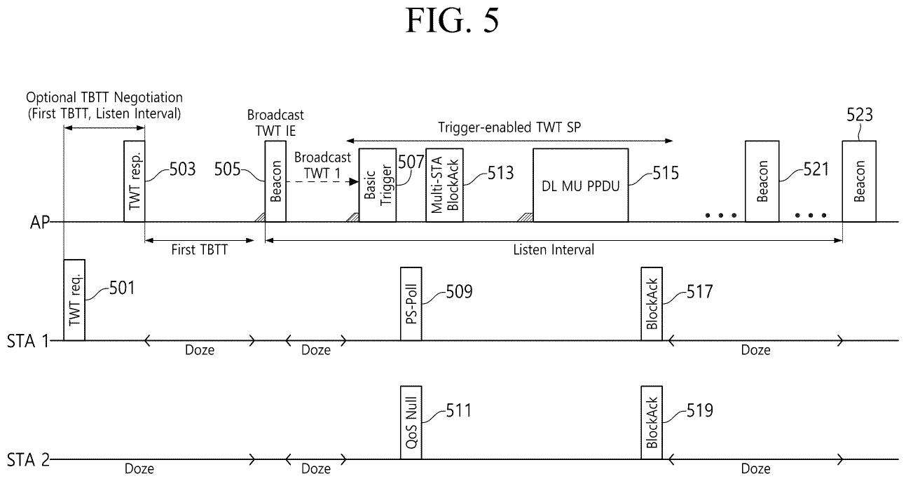

FIG. 5 shows an example of broadcast TWT operation in accordance with an embodiment. The operation depicted in FIG. 5 is for illustration purposes and does not limit the scope of this disclosure to any particular implementations.

In FIG. 5, STA 1 and STA 2 are TWT scheduled STAs, and AP is a TWT scheduling AP. In the example of FIG. 5, STA 1 and AP may have optional TBTT (target beacon transmission time) negotiation by exchanging TWT request frame 501 and TWT response frame 503. After the first TBTT, the AP sends a beacon frame 505 including a broadcast TWT element that indicates a broadcast TWT SP. During the TWT SP, the AP may send trigger frames, or downlink buffer-able units (BUs) to the TWT scheduled STAs (STA 1 and STA 2). STA 1 and STA 2 wake to receive the beacon frame 505 to determine the broadcast TWT. During the trigger-enabled TWT SP, the AP sends a basic trigger frame 507 to STA 1 and STA 2 which indicate that they are awake during the TWT SP. STA 1 indicates that it is awake by sending a PS-Poll frame 509, while STA 2 indicates that it is awake by sending a QoS Null frame 511 in response to the basic trigger frame 507. STA 1 and STA 2 receive their DL BUs in a subsequent frame exchange (e.g., Multi-STA BlockAck 513, DL MU PPDU 515, and BlockAck 517 and 519) with the AP and go to doze state out of the TWT SP. After the TWT SP, the AP sends beacon frames 521 and 523 periodically to STA 1 and STA 2. As illustrated, the AP can advertise/announce and maintain multiple broadcast TWT schedules in the BSS. When a change is made to any of the broadcast TWT schedules, it may affect all STAs that are members of the particular TWT schedule.

TWT enhancements for MLDs have recently been introduced in IEEE 802.11be specification. For individual TWT agreements between two MLDs, a STA affiliated with an MLD, which is a TWT requesting STA, may indicate the link(s) that are requested for setting up TWT agreement(s) in the Link ID Bitmap subfield, if present, of a TWT element in the TWT request. If only one link is indicated in the Link ID Bitmap subfield of the TWT element, a single TWT agreement is requested for the corresponding STA affiliated with the same MLD, which is operating on the indicated link. The Target Wake Time field of the TWT element shall be in reference to the time synchronization function (TSF) time of the link indicated by the TWT element. A TWT responding STA affiliated with a peer MLD that receives a TWT request that contains a Link ID Bitmap subfield in a TWT element responds with a TWT response that indicates the link(s) in the Link ID Bitmap field of a TWT element. The link(s), if present, in the TWT element carried in the TWT response, may be the same as the link(s) indicated in the TWT element of the soliciting TWT request.

Restricted TWT (R-TWT) operation is another important feature for the next generation WLAN. The R-TWT operation provides better support for latency sensitive applications. For instance, traffic in real time applications has stringent requirements in terms of latency and its jitter along with certain reliability constraint. Such traffic may be referred to as latency sensitive traffic in this disclosure. The R-TWT operation may offer a protected service period (SP) for R-TWT member STAs by sending Quiet elements to non-member STAs in the BSS in the R-TWT schedule. In some implementations, a quiet interval of the Quiet element overlaps with the initial portion of the R-TWT SP. Therefore, it may provide greater channel access opportunities to R-TWT member STAs than non-member STAs, thereby improving the flow of latency sensitive traffic.

Interference from one BSS may often lead to performance issues for STAs and APs in neighboring BSSs. This interference may result in overall throughput degradation in the network. The Overlapping BSS (OBSS) interference may also increase the overall latency since it takes more time to access the channel due to the interference occupying the channel. If a STA in a BSS has latency-sensitive traffic, this delay in channel access may significantly impede the performance of the STA's latency-sensitive applications. To address these issues, a TWT-based multi-AP coordination is considered for the next generation WLAN system.

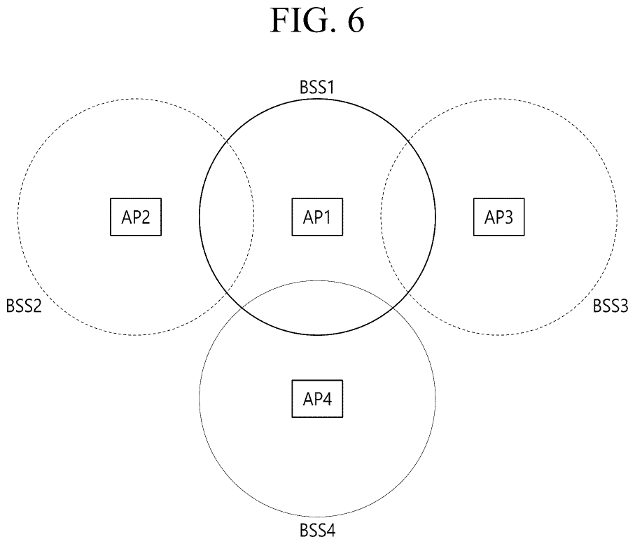

FIG. 6 shows an example of a typical AP development scenario for TWT-based multi-AP coordination in accordance with an embodiment.

In FIG. 6, AP 1, AP 2, AP 3, and AP 4 form BSS 1, BSS2, BSS 3, and BSS4, respectively. In some embodiments, AP 1, AP 2, AP 3, and AP 4 may be members of an TWT coordination AP set and are participating in the TWT-based multi-AP coordination. As shown, BSS 1 overlaps with BSS 2, BSS 3, and BSS 4.

Referring to FIG. 6, the APs may serve as be TWT scheduling APs in their respective BSSs. The APs participating in the TWT-based multi-AP coordination may directly exchange frames among the APs to negotiate the TWT multi-AP coordination.

In this disclosure, a TWT sharing AP may refer to an AP that has or intends to have an TWT schedule or an TWT agreement in its BSS and initiates a TWT coordination procedure with APs in the OBSS for better protection of the TWT SP, for example, to increase channel access opportunities or reduce OBSS interference. Additionally, a TWT shared AP may refer to an AP that receives the TWT coordination request from the TWT sharing AP. In an embodiment, a TWT sharing AP may share or propose TWT information of the STAs with a TWT shared AP, which may be referred to as ‘coordinated TWT (C-TWT).’ This coordination may help in mitigating OBSS interference or enhancing signal power during TWT SP.

In a conventional TWT operation, a TWT agreement and a TWT schedule are set up between an AP and a non-AP STA only when both agree on a complete set of TWT parameters. However, in the TWT-based MAP coordination, the TWT shared APs may not be able to comply with the complete set of TWT parameters requested by the TWT sharing AP for various reasons. Consequently, from the TWT sharing AP's perspective, even partial compliance with TWT parameters or partial fulfillment of the C-TWT request by the TWT sharing AP may be useful and beneficial. In some embodiments, in the R-TWT operation, it may improve the channel access opportunities on average for the membered STAs. However, there is currently no mechanism in the WLAN system that allows agreement or coordination on a partial set of TWT parameters between the two APs.

The present disclosure provides a mechanism to negotiate and coordinate on a partial set of TWT parameters between a TWT sharing AP and a TWT shared AP for the TWT-based MAP coordination.

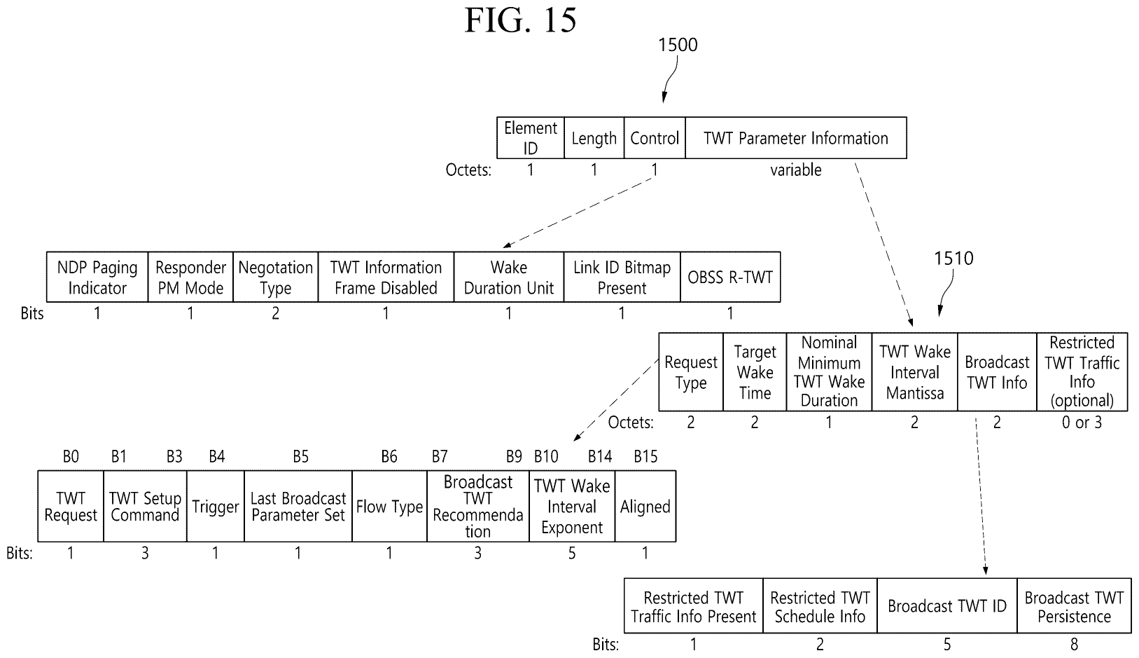

In some embodiments, when a TWT sharing AP and a TWT shared AP negotiates for a TWT-based MAP coordination, the TWT sharing AP may request coordination on a complete set or a partial set of TWT parameters. The complete set of TWT parameters may include, for example and without limitation, all timing-related parameters and TWT persistence parameters. In an embodiment, a complete set of TWT parameters may include all TWT parameters in the TWT parameter set field in the TWT element corresponding to the TWT schedule or TWT agreement for which the TWT sharing AP is requesting the coordination. An example of the TWT parameter set field and the TWT element will be provided later with reference to FIG. 15.

In some embodiments, when a TWT sharing AP negotiates or send a C-TWT request to a TWT shared AP including a set of TWT parameters, the TWT shared AP may agree on a partial set of TWT parameters for TWT-based MAP coordination but may not agree on the remaining TWT parameters. In some embodiments, when the TWT shared AP agrees to coordinate on only a partial set of TWT parameters, the TWT sharing AP may still consider that the TWT coordination negotiation is successful. Such TWT coordination may be referred to as ‘a partial TWT coordination’ or ‘a partial TWT agreement’ in this disclosure.

Hereinafter, various examples in which a TWT shared AP agrees on a partial set of TWT parameters for TWT-based MAP coordination are provided in accordance with various embodiments.

In some embodiments, a TWT shared AP may agree to support or coordinate for a partial set of TWT parameters among a compete set of TWT parameters for the TWT coordination requested from a TWT sharing AP due to some constraints that may be local to a BSS of the TWT shared AP. In an aspect, respecting the remaining TWT parameters for the TWT coordination with the TWT sharing AP may cause resource deprivation for the STAs in the BSS of the TWT shared AP. For example, the TWT shared AP in its BSS may serve latency sensitive traffic for one or more associated STAs. The STAs may have established a stream classification service (SCS) with the TWT shared AP for high priority traffic (e.g., low latency traffic). The service period and interval for the high priority traffic may overlap with the coordinated TWT SP requested by the TWT sharing AP. In this scenario, when the TWT shared AP agrees to the request from the TWT sharing AP for the coordination of the TWT SP that overlaps with the SCS service period for the high priority traffic, the QoS (Quality of Service) requirement for the high priority traffic may not be satisfied. In this scenario, the TWT shared AP may agree on a partial portion of the requested TWT SP that does not overlap with the existing SCS service period established with the TWT shared AP.

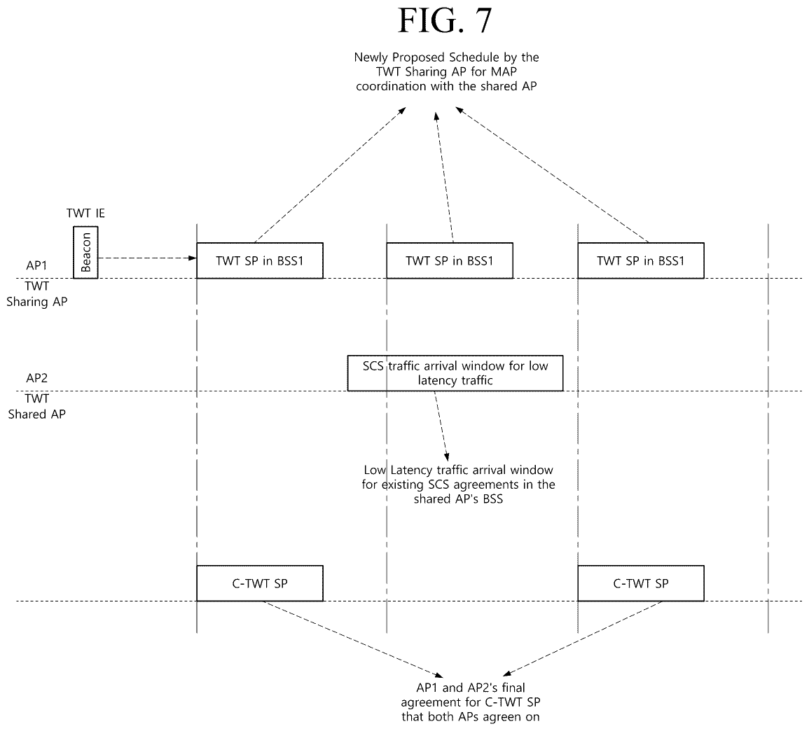

FIG. 7 shows an example scenario of a partial TWT agreement in accordance with an embodiment. The scenario and operations depicted in FIG. 7 are for illustration purposes and do not limit the scope of this disclosure to any particular implementations.

In FIG. 7, AP 1 is a TWT sharing AP and AP 2 is a TWT shared AP for TWT-based MAP coordination. AP 1 forms BSS 1 and AP 2 forms BSS 2. The top line in FIG. 7 shows proposed TWT SPs by the AP 1 for TWT-based MAP coordination with AP 2. In this example, AP 1 requests TWT coordination for three TWT SPs. On the other hand, AP 2 has already established SCS agreement with its associated STA in BSS 2. The second line in FIG. 7 shows an SCS traffic arrival window for low latency traffic which overlaps with the second TWT SP proposed by AP 1. Therefore, AP 2 agrees to coordinate only for the first and third TWT SPs and rejects the coordination for the second TWT SP. Consequently, the first and third TWT SPs become C-TWT SPs as depicted in the bottom line of FIG. 7.

In some embodiments, a TWT shared AP may already have one or more TWT schedules established in its BSS during which the TWT shared AP serves latency sensitive traffic or high priority traffic to its own associated STAs. In this scenario, if a TWT sharing AP newly requests a coordinated TWT schedule which partially overlaps with one or more existing TWT SPs, the TWT shared AP may not agree on the portion of the requested C-TWT SP set that overlaps with existing TWT SPs in the BSS of the TWT shared AP.

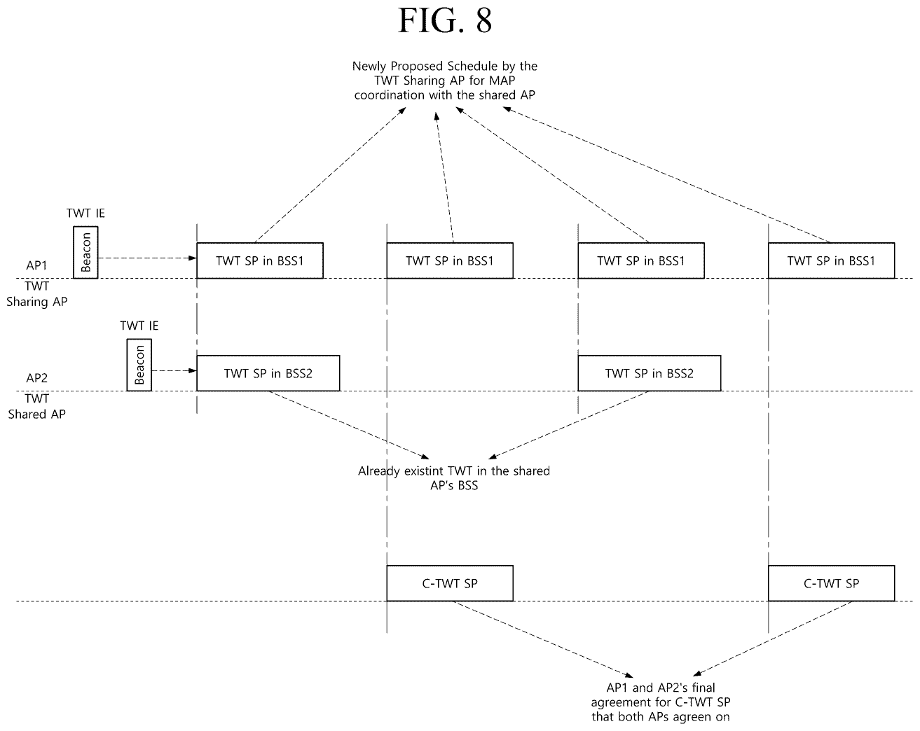

FIG. 8 shows another example scenario of a partial TWT agreement in accordance with an embodiment. The scenario and operations depicted in FIG. 8 are also for illustration purposes and do not limit the scope of this disclosure to any particular implementations.

In FIG. 8, AP 1 is a TWT sharing AP and AP 2 is a TWT shared AP for TWT-based MAP coordination. AP 1 forms BSS 1 and AP 2 forms BSS 2. The top line in FIG. 8 shows newly proposed TWT SPs by the AP 1 for TWT-based MAP coordination with AP 2. In this example, AP 1 requests TWT coordination for four TWT SPs. On the other hand, AP 2 already has an existing TWT schedule with its associated STAs in BSS 2. The second line in FIG. 8 shows TWT SPs established already established in BSS 2. The first and third TWT SPs in BSS 2 overlap in time with the first and third TWT SPs in BSS1, respectively. Therefore, AP 2 agrees to coordinate only for the second and fourth TWT SPs and rejects the coordination for the first and third TWT SPs. As a result, the second and fourth TWT SPs become C-TWT SPs as depicted in the bottom line of FIG. 8.

In some embodiments, a TWT sharing AP requests the TWT-based MAP coordination to a TWT shared AP. The TWT schedule or agreement may be characterized or identified by a TWT parameter set. The TWT shared AP may agree to a different TWT parameters than those proposed by the TWT sharing AP. For example, the TWT shared AP may agree to a different periodicity for the TWT SPs. More specifically, the TWT shared AP may agree to a different TWT wake interval than the TWT wake interval requested by the TWT sharing AP.

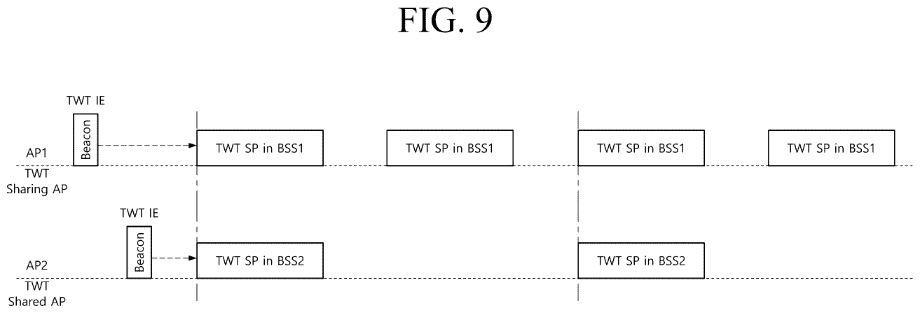

FIG. 9 shows another example scenario of a partial TWT agreement in accordance with an embodiment. The scenario and operations depicted in FIG. 9 are also for illustration purposes and do not limit the scope of this disclosure to any particular implementations.

In FIG. 9, AP 1 is a TWT sharing AP and AP 2 is a TWT shared AP for TWT-based MAP coordination. AP 1 forms BSS 1 and AP 2 forms BSS 2. The top line in FIG. 9 shows newly proposed TWT SPs by AP 1 for TWT-based MAP coordination with AP 2. In this example, AP 1 proposes four TWT SPs to AP 2. However, AP 2 agrees only for the first and third TWT SPs with different TWT wake intervals than those requested by AP 1 and reject the coordination for the second and fourth TWT SPs. In the example of FIG. 9, the periodicity of TWT SP in BSS 2 becomes double the periodicity of TWT SP in BSS 1 as depicted in the bottom line of FIG. 9. Therefore, the starting times of the first and the second TWT SPs in BSS 2 align with those of the first and third TWT SPs in BSS 1.

In some embodiments, a TWT sharing AP requests the TWT-based MAP coordination to a TWT shared AP. The TWT schedule or agreement may be characterized or identified by a TWT parameter set. The TWT shared AP may agree to a different TWT SP duration than that requested by the TWT sharing AP.

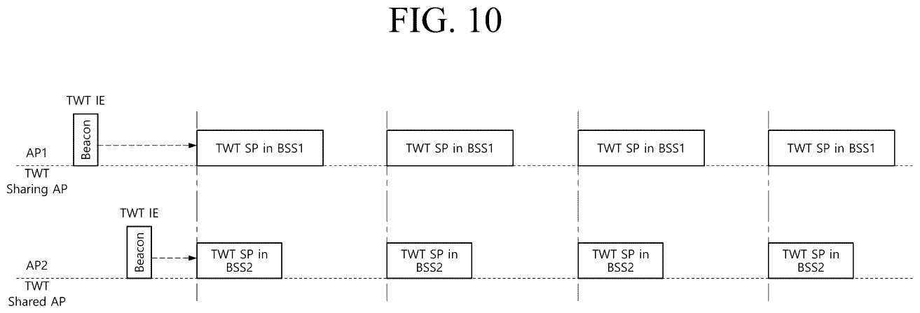

FIG. 10 shows another example scenario of a partial TWT agreement in accordance with an embodiment. The scenario and operations depicted in FIG. 10 are also for illustration purposes and do not limit the scope of this disclosure to any particular implementations.

In FIG. 10, AP 1 is a TWT sharing AP and AP 2 is a TWT shared AP for TWT-based MAP coordination. AP 1 forms BSS 1 and AP 2 forms BSS 2. The top line in FIG. 10 shows newly proposed TWT SPs by the AP 1 for TWT-based MAP coordination with AP 2. In this example, AP 1 proposes four TWT SPs. In response to the request, AP 2 agrees the coordination for all four TWT SPs, but with different TWT SP duration. Referring to the bottom line of FIG. 10, the starting times of all TWT SPs in BSS 2 align with those of corresponding TWT SPs in BSS 1 while the durations of TWT SPs in BSS 2 are shorter than those of TWT SPs in BSS 1.

In some embodiments, a TWT sharing AP requests the TWT-based MAP coordination to a TWT shared AP. The TWT schedule or agreement may be characterized or identified by a TWT parameter set. The TWT shared AP may agree to different persistence parameters than those requested by the TWT sharing AP. In an embodiment, the TWT shared AP may prefer to end the multi-AP coordination earlier than the time requested by the TWT sharing AP.

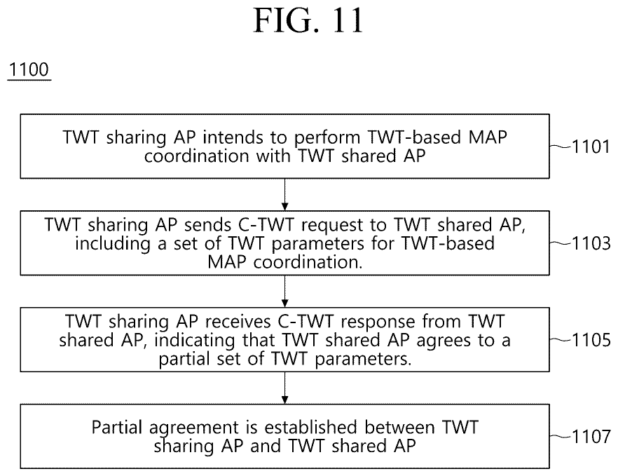

FIG. 11 shows a flow chart of an example operation of a partial TWT coordination in accordance with an embodiment. For explanatory and illustration purposes, the example process 1100 may be performed in TWT sharing AP. Although one or more operations are described or shown in particular sequential order, in other embodiments the operations may be rearranged in a different order, which may include performance of multiple operations in at least partially overlapping time periods.

The process 1100 may begin in operation 1101. In operation 1101, a TWT sharing AP intends to perform TWT-based MAP coordination with a TWT shared AP.

In operation 1103, the TWT sharing AP transmits a C-TWT request frame to the TWT shared AP. The C-TWT request frame may include a set of TWT parameters for TWT-based MAP coordination.

In operation 1105, the TWT sharing AP receives a C-TWT response frame from the TWT shared AP. The C-TWT response frame indicates that the TWT shared AP agrees to a partial set of TWT parameters, not the complete set of TWT parameters requested by the TWT sharing AP. In operation 1105, the partial set of TWT parameters is acceptable or agreeable to the TWT sharing AP. Then, the process 1100 proceeds to operation 1107.

In operation 1107, a partial TWT agreement or coordination is established between the TWT sharing AP and the TWT shared AP based on the partial set of TWT parameters agreed by both APs.

An example format of the C-TWT request frame is shown in Table 1 below. The C-TWT request frame may include a Category field, an Unprotected SIG Action field, a Dialog Token field, a TWT Coordination Mode field, and one or more TWT elements. The Category field may indicate a category of the C-TWT request frame. The Unprotected SIG Action field may include a field value associated with the C-TWT request frame to differentiate the unprotected SIG action frame formats. The Dialog Token field may include a value to identify the C-TWT request/response transaction. The TWT Coordination Mode field may indicate whether the C-TWT request is for full TWT coordination or partial TWT coordination. In an embodiment, the C-TWT Coordination Mode field is set to 1, it may indicate that the C-TWT request is for full TWT coordination. Otherwise, it may indicate that the C-TWT request is for partial TWT coordination. Each of the one or more TWT elements may correspond to a particular TWT schedule on which the TWT sharing AP requests to coordinate with the TWT shared AP. Further, each TWT element may have one or more TWT parameter sets. For example, a broadcast TWT element includes one or more TWT parameter sets, while an individual TWT element includes one TWT parameter set. Each TWT parameter set may correspond to a different TWT schedule on which the TWT sharing AP intends to coordinate with the TWT shared AP. All information related to the TWT schedule is included in one or more TWT parameter sets within the TWT element.

TABLE 1

| Order | Information |
|---|---|
| 1 | Category |
| 2 | Unprotected S1G Action |
| 3 | Dialog Token |
| 4 | TWT Coordination Mode |
| 5 | One or more TWT element |

An example format of the C-TWT response frame is shown in Table 2 below. The C-TWT response frame may include a Category field, an Unprotected S1G Action field, a Dialog Token field, a TWT Coordination Mode field, and one or more TWT element. The Category field may indicate a category of the C-TWT response frame. The Unprotected SIG Action field may include a field value associated with the C-TWT response frame to differentiate the unprotected SIG action frame formats. The Dialog Token field may include a value to identify the C-TWT request/response transaction. The TWT Coordination Mode field may indicate whether the TWT shared AP agrees to a full TWT coordination or a partial TWT coordination. In an embodiment, the C-TWT Coordination Mode field is set to 1, it may indicate that the C-TWT response is for full TWT coordination. Otherwise, it may indicate that the C-TWT response is for partial TWT coordination. Each of the one or more TWT elements may correspond to a response to a particular TWT schedule requested by with the TWT sharing AP. Further, each TWT element may have one or more TWT parameter sets. For example, a broadcast TWT element includes one or more TWT parameter sets, while an individual TWT element includes one TWT parameter set. Each TWT parameter set may correspond to a response to a request for a particular C-TWT request from the TWT sharing AP. All information related to the TWT schedule is included in one or more TWT parameter sets within the TWT element. For each TWT parameter set included in the C-TWT response frame, the TWT shared AP may indicate whether it accepts or rejects TWT parameters, or suggest alternative parameters for the corresponding C-TWT schedule requested by the TWT sharing AP.

TABLE 2

| Order | Information |
|---|---|
| 1 | Category |
| 2 | Unprotected S1G Action |
| 3 | Dialog Token |
| 4 | TWT Coordination Mode |
| 5 | One or more TWT |

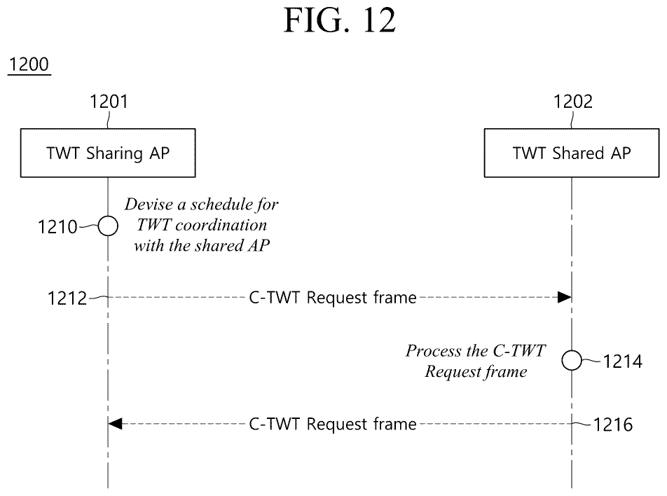

FIG. 12 shows an example process 1200 of frame exchanges in TWT-based MAP coordination in accordance with an embodiment. The scenario and operations depicted in FIG. 12 are also for illustration purposes and do not limit the scope of this disclosure to any particular implementations.

Referring to FIG. 12, the process 1200 may begin in operation 1210. In operation 1210, a TWT sharing AP 1201 intends to perform TWT-based MAP coordination with a TWT shared AP 1202. Therefore, the TWT sharing AP 1201 devises a TWT schedule for TWT-based MAP coordination.

In operation 1212, the TWT sharing AP 1201 transmits a C-TWT request frame to the TWT shared AP 1202.

In operation 1214, upon receiving the C-TWT request frame from the TWT sharing AP 1201, the TWT shared AP 1202 process the received C-TWT request frame. In this example of FIG. 12, the TWT shared AP 1202 accepts that C-TWT schedule requested by the TWT sharing AP 1201. In an embodiment, the TWT shared AP 1202 may accept a partial set of TWT parameters requested by the TWT sharing AP 1201.

In operation 1216, the TWT shared AP 1202 transmits a C-TWT response frame to the TWT sharing AP 1201. The C-TWT response frame indicates that the TWT shared AP 1202 accepts that C-TWT schedule requested by the TWT sharing AP 1201. After the TWT sharing AP 1201 receives the C-TWT response frame, the requested C-TWT schedule is established for the TWT coordination between the TWT sharing AP 1201 and the TWT shared AP 1202. In an embodiment, the C-TWT response frame may indicate that the TWT shared AP 1202 accepts the partial set of TWT parameters requested by the TWT sharing AP 1201. In this scenario, a partial portion of the requested C-TWT schedule is established for the TWT coordination between the TWT sharing AP 1201 and the TWT shared AP 1202.

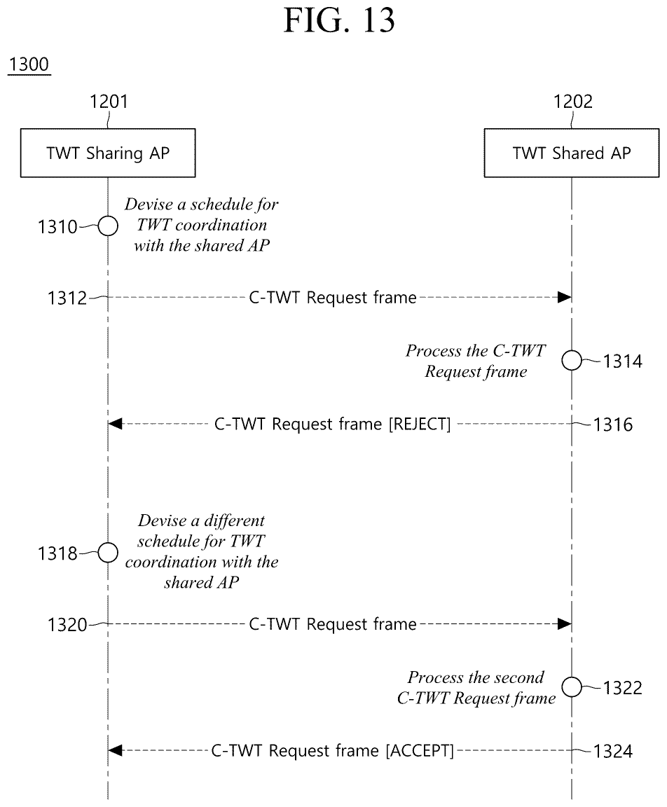

FIG. 13 shows another example process 1300 of frame exchanges in TWT-based MAP coordination in accordance with an embodiment. The scenario and operations depicted in FIG. 13 are also for illustration purposes and do not limit the scope of this disclosure to any particular implementations.

Referring to FIG. 13, the process 1300 begins in operation 1310. In operation 1310, a TWT sharing AP 1201 intends to perform TWT-based MAP coordination with a TWT shared AP 1202. Therefore, the TWT sharing AP 1201 devises a TWT schedule for TWT-based MAP coordination.

In operation 1312, the TWT sharing AP 1201 transmits a C-TWT request frame to the TWT shared AP 1202.

In operation 1314, upon receiving the C-TWT request frame from the TWT sharing AP 1201, the TWT shared AP 1202 process the received C-TWT request frame. In this example, the TWT shared AP 1202 determines to reject the C-TWT schedule requested by the TWT sharing AP 1201.

In operation 1316, the TWT shared AP 1202 transmits a C-TWT response frame to the TWT sharing AP 1201. The C-TWT response frame indicates that the TWT shared AP 1202 rejects the C-TWT schedule requested by the TWT sharing AP 1201.

In operation 1318, the TWT sharing AP 1201 may devise a second schedule for TWT-based MAP coordination.

In operation 1320, the TWT sharing AP 1201 transmits a second C-TWT request frame to the TWT shared AP 1202. The second C-TWT request frame indicates a second C-TWT schedule for TWT-based MAP coordination.

In operation 1322, upon receiving the second C-TWT request frame from the TWT sharing AP 1201, the TWT shared AP 1202 process the second C-TWT request frame. In this example, the TWT shared AP 1202 accepts the second C-TWT schedule requested by the TWT sharing AP 1201.

In operation 1324, the TWT shared AP 1202 transmits a second C-TWT response frame to the TWT sharing AP 1201. The second C-TWT response frame indicates that the TWT shared AP 1202 accepts the second C-TWT schedule requested by the TWT sharing AP 1201. After the TWT sharing AP 1201 receives the second C-TWT response frame, the second C-TWT schedule is established for the TWT-based MAP coordination between the TWT sharing AP 1201 and the TWT shared AP 1202.

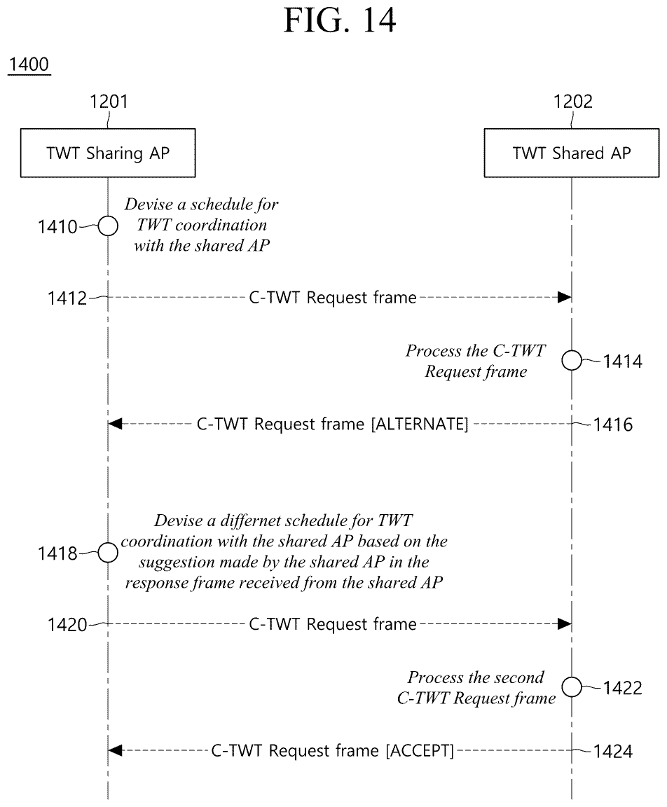

FIG. 14 shows another example process 1400 of frame exchanges in TWT-based MAP coordination in accordance with an embodiment. The scenario and operations depicted in FIG. 14 are also for illustration purposes and do not limit the scope of this disclosure to any particular implementations.

Referring to FIG. 14, the process begins in operation 1410. In operation 1410, a TWT sharing AP 1201 intends to perform TWT-based MAP coordination with a TWT shared AP 1202. Therefore, the TWT sharing AP 1201 devises a TWT schedule for TWT-based MAP coordination.

In operation 1412, the TWT sharing AP 1201 transmits a C-TWT request frame to the TWT shared AP 1202.

In operation 1414, upon receiving the C-TWT request frame from the TWT sharing AP 1201, the TWT shared AP 1202 process the received C-TWT request frame. The TWT shared AP 1202 determines to suggest an alternative set of TWT parameters.

In operation 1416, the TWT shared AP 1202 transmits a C-TWT response frame to the TWT sharing AP 1201. The C-TWT response frame indicates that the TWT shared AP 1202 suggests the alternative set of TWT parameters. In this scenario, the TWT setup command subfield, which is explained later with reference to FIG. 15, may be set as Alternate TWT.

In operation 1418, the TWT sharing AP 1201 may devise a second schedule for TWT coordination based on the suggestion made by the TWT shared AP 1202.

In operation 1420, the TWT sharing AP 1201 transmits a second C-TWT request frame to the TWT shared AP 1202. The second C-TWT request frame indicates a second C-TWT schedule including a revised set of TWT parameters based on the suggestion by the TWT shared AP 1202.

In operation 1422, upon receiving the second C-TWT request frame from the TWT sharing AP 1201, the TWT shared AP 1202 process the second C-TWT request frame. The TWT shared AP 1202 may accept that the second C-TWT schedule requested by the TWT sharing AP.

In operation 1424, the TWT shared AP 1202 transmits a second C-TWT response frame to the TWT sharing AP 1201. The second C-TWT response frame indicates that the TWT shared AP 1202 accepts the second C-TWT schedule requested by the TWT sharing AP. After the TWT sharing AP 1201 receives the second C-TWT response frame, the second C-TWT schedule is established for the TWT coordination between the TWT sharing AP 1201 and the TWT shared AP 1202.

FIG. 15 shows an example format of the TWT element in accordance with an embodiment.

In FIG. 15, the TWT element 1500 may include an Element ID field, a length field, a Control field, and one or more a TWT Parameter Information field. The Element ID field may include information to identify the TWT element 1500. The Length field may indicate a length of the TWT element 1500.

The Control field may include a null data PPDU (physical layer protocol data unit) (NDP) Paging Indicator subfield, a Responder power management (PM) Mode subfield, a Negotiation Type subfield, a TWT Information Frame Disabled subfield, a Wake Duration Unit subfield, a Link ID Bitmap Present subfield, and an OBSS R-TWT subfield. The NDP Paging Indicator subfield may indicate whether an NDP paging field is present or not in an Individual TWT Parameter Set field. The Responder PM Mode subfield may indicate the power management mode, such as active mode and power save (PS) mode. The negotiation Type subfield may indicate whether the information included in the TWT element is for the negotiation of parameters of broadcast or individual TWT or Wake TBTT (target beacon transmission time) interval. The MSB (most significant bit) of the Negotiation Type subfield is the Broadcast field which indicates if one or more Broadcast TWT Parameter Sets are contained in the TWT element. The TWT Information Frame Disabled subfield may indicate whether the reception of TWT information frame is disabled by the STA. The Wake Duration Unit subfield may indicate the unit of the Nominal Minimum TWT Wake Duration subfield in the Broadcast TWT Parameter Set field. The Link ID Bitmap Present subfield may indicate the presence of the Link ID Bitmap field in the Individual TWT Parameter Set field. The OBSS R-TWT subfield may indicate whether the R-TWT schedules corresponding to the Broadcast TWT Parameter Set fields in the TWT element are the R-TWT schedule of the neighboring BSS. When the OBSS R-TWT subfield is set to ‘1’, it may indicate that the R-TWT schedules in the TWT element are the R-TWT schedule of the neighboring BSS. Otherwise, it indicates that there is no neighboring BSS's R-TWT schedule in the TWT element.

The TWT Parameter information field includes an individual TWT parameter set field or one or more Broadcast TWT Parameter Set fields. For the convenience of description, FIG. 15 illustrates the Broadcast TWT Parameter Set fields. The Broadcast TWT Parameter Set field 1510 may include a Request Type field, a Target Wake Time field, a Nominal Minimum TWT Wake Duration field, a TWT Wake Interval Mantissa field, a Broadcast TWT Info field, and an optional Restricted TWT traffic Info field.

The Request Type field of the Broadcast TWT Parameter Set field 1510 can be used to indicate the presence of the aligned TWT schedule. Referring to FIG. 15, the Request Type field includes a TWT Request subfield, a TWT Setup Command subfield, a Trigger subfield, a Last Broadcast Parameter Set subfield, a Flow Type subfield, a Broadcast TWT Recommendation subfield, a TWT Wake Interval Exponent subfield, and an Aligned subfield. The Request Type field may be usable for Broadcast TWT operation.

The TWT Request subfield may indicate if the transmitting STA is a TWT scheduling AP (or STA) or a TWT scheduled STA (or AP). The TWT Setup Command subfield may indicate the type of TWT command, such as Request TWT, Suggest TWT, Demand TWT, TWT Grouping, Accept TWT, Alternate TWT, Dictate TWT and Reject TWT. The Trigger subfield may indicate whether the TWT SP indicated by the TWT element includes triggering frames. The Last Broadcast Parameter Set subfield may indicate whether another Broadcast TWT Parameter Set field follows this Broadcast TWT Parameter Set field. The Flow Type subfield may indicate the type of interaction, for example, an announced TWT or an unannounced TWT between the TWT scheduled STA and the TWT scheduling AP at TWT. The Broadcast TWT Recommendation subfield may indicate recommendations on the types of frames that are transmitted by TWT scheduled STAs and TWT scheduling AP during the broadcast TWT SP. For instance, the types of frames may be PS-Poll and QoS Null frames, management frames, control response frames, or No constraints on the frame. The TWT Wake Interval Exponent subfield may indicate the value of the exponent of the TWT wake interval value. The Aligned subfield may indicate whether one or more of other links of the AP MLD have broadcast TWT schedules that are aligned with the corresponding schedule. More specifically, if the subfield is set to 1, it may indicate that there are one or more schedules on other links that are aligned with the TWT schedule identified by the Broadcast TWT Parameter Set field. Otherwise, the schedule is no such schedule on the other links.

The Target Wake Time field may include an unsigned integer corresponding to a TSF (time synchronization function) time for the TWT scheduled STA to wake up. The Target Wake Time field may indicate the start time of the TWT service period (SP) on the corresponding link. The Nominal Minimum TWT Wake Duration field may indicate the minimum amount of time that the TWT scheduled STA is expected to be awake in order to complete the frame exchanges for the period of TWT wake interval. The TWT wake interval is the average time that the TWT scheduled STA expects to elapse between successive TWT SPs. The TWT Wake Interval Mantissa field may indicate the value of the mantissa of the TWT wake interval value. The Broadcast TWT Info field may include information related to the broadcast TWT, such as a restricted TWT traffic info present field, a restricted TWT schedule info field, a Broadcast TWT ID field and a Broadcast TWT Persistence field. The restricted TWT traffic info present field indicates whether the restricted TWT traffic info field is present. The restricted TWT schedule info field indicates whether an active R-TWT schedule is active. The Broadcast TWT ID field indicates a specific broadcast TWT for which the transmitting STA is providing TWT parameters. The Broadcast TWT persistence field indicates the number of TBTTs during which the Broadcast TWT SPs corresponding to this broadcast TWT parameter set are present.

According to various embodiments, a mechanism to negotiate and coordinate between a TWT sharing AP and a TWT shared AP on a partial set of TWT parameters for TWT-based MAP coordination. Therefore, the TWT sharing AP can consider the TWT coordination negotiation successful for the partial agreement. It will improve the channel access opportunities for STAs and APs participating in the TWT-based MAP coordination.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the invention. The word exemplary is used to mean serving as an example or illustration. To the extent that the term “include,” “have,” or the like is used, such term is intended to be inclusive in a manner similar to the term “comprise” as “comprise” is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously or may be performed as a part of one or more other steps, operations, or processes. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using a phrase means for or, in the case of a method claim, the element is recited using the phrase step for.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. This method of disclosure is not to be interpreted as reflecting an intention that the claimed subject matter requires more features than are expressly recited in each claim. Rather, as the following claims reflect, inventive subject matter lies in less than all features of a single disclosed configuration or operation. The following claims are hereby incorporated into the detailed description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. A first access point (AP) in a wireless network, comprising:
a memory; and
a processor coupled to the memory, the processor configured to cause:
transmitting, to a second AP, a first frame requesting target wake time (TWT) based multi-AP coordination, the first frame including a set of TWT parameters for the TWT based multi-AP coordination;
receiving, from the second AP, a second frame indicating acceptance on a partial set of the TWT parameters requested from the first AP; and
establishing the TW based multi-AP coordination with the second AP based on the partial set of TWT parameters.

2. The first AP of claim 1, wherein the first frame includes an indication representing whether the first AP requests a complete acceptance for the set of the TWT parameters or a partial acceptance for the set of TWT parameters.

3. The first AP of claim 1, wherein the second frame includes an indication representing whether the second AP provides a complete acceptance for the set of the TWT parameters or a partial acceptance for the set of the TWT parameters.

4. The first AP of claim 1, wherein the first frame includes one or more TWT elements, each TWT element associated with a respective one of one or more TWT schedules that the first AP requests for the TWT based multi-AP coordination.

5. The first AP of claim 4, wherein each TWT element includes one or more TWT parameter sets, each TWT parameter set associated with a respective one of one or more TWT schedules which the first AP intends to coordinate on with the second AP.

6. The first AP of claim 1, wherein the second frame includes one or more TWT elements, each TWT element associated with a response to a respective one of one or more TWT schedules requested by the first AP.

7. The first AP of claim 6, wherein each TWT element includes one or more TWT parameter sets, each TWT parameter set associated with a response to a respective one of one or more TWT schedules requested by the first AP.

8. The first AP of claim 7, wherein each TWT parameter set indicates acceptance, rejection, or alternative to a TWT schedule requested by the first AP.

9. A first access point (AP) in a wireless network, comprising:
a memory; and
a processor coupled to the memory, the processor configured to cause:
receiving, from a second AP, a first frame requesting target wake time (TWT) based multi-AP coordination, the first frame including a set of TWT parameters for the TWT based multi-AP coordination;
transmitting, to the second AP, a second frame indicating acceptance on a partial set of the TWT parameters requested from the second AP; and
establishing the TWT based multi-AP coordination with the second AP based on the partial set of TWT parameters.

10. The first AP of claim 9, wherein the first frame includes an indication representing whether the second AP requests a complete acceptance for the set of the TWT parameters or a partial acceptance for the set of TWT parameters.

11. The first AP of claim 9, wherein the second frame includes an indication representing whether the first AP provides a complete acceptance for the set of the TWT parameters or a partial acceptance for the set of the TWT parameters.

12. The first AP of claim 9, wherein the first frame includes one or more TWT elements, each TWT element associated with a respective one of one or more TWT schedules that the second AP requests for the TWT based multi-AP coordination.

13. The first AP of claim 12, wherein each TWT element includes one or more TWT parameter sets, each TWT parameter set associated with a respective one of one or more TWT schedules which the second AP intends to coordinate on with the first AP.

14. The first AP of claim 9, wherein the second frame includes one or more TWT elements, each TWT element associated with a response to a respective one of one or more TWT schedules requested by the second AP.

15. The first AP of claim 14, wherein each TWT element includes one or more TWT parameter sets, each TWT parameter set associated with a response to a respective one of one or more TWT schedules requested by the second AP.

16. The first AP of claim 15, wherein each TWT parameter set indicates acceptance, rejection, or alternative to a TWT schedule requested by the second AP.

17. A method performed by a first access point (AP) in a wireless network, comprising:
transmitting, to a second AP, a first frame requesting target wake time (TWT) based multi-AP coordination, the first frame including a set of TWT parameters for the TWT based multi-AP coordination;
receiving, from the second AP, a second frame indicating acceptance on a partial set of the TWT parameters requested from the first AP; and
establishing the TW based multi-AP coordination with the second AP based on the partial set of TWT parameters.

18. The method of claim 17, wherein:
the first frame includes an indication representing whether the first AP requests a complete acceptance for the set of the TWT parameters or a partial acceptance for the set of TWT parameters; and
the second frame includes an indication representing whether the second AP provides the complete acceptance for the set of the TWT parameters or the partial acceptance for the set of the TWT parameters.

19. The method of claim 17, wherein:
the first frame includes one or more TWT elements, each TWT element associated with a respective one of one or more TWT schedules that the first AP requests for the TWT based multi-AP coordination; and
each TWT element includes one or more TWT parameter sets, each TWT parameter set associated with a respective one of one or more TWT schedules which the first AP intends to coordinate on with the second AP.

20. The method of claim 17, wherein:
the second frame includes one or more TWT elements, each TWT element associated with a response to a respective one of one or more TWT schedules requested by the first AP; and
each TWT element includes one or more TWT parameter sets, each TWT parameter set associated with a response to a respective one of one or more TWT schedules requested by the first AP.
